(19) United States
(12) Patent Application Publication
(10) Pub. No.: US 2018/0152626 A1
(43) Pub. Date: May 31, 2018

(54) IMAGING DEVICE

(71) Applicants: Kei MATSUOKA, Tokyo (JP); Yoshitaka TAKAHASHI, Tokyo (JP)

(72) Inventors: Kei MATSUOKA, Tokyo (JP); Yoshitaka TAKAHASHI, Tokyo (JP)

(21) Appl. No.: 15/814,456

(22) Filed: Nov. 16, 2017

(30) Foreign Application Priority Data
Nov. 30, 2016 (JP) 2016-232023

(51) Int. Cl. H04N 5/232; G06F 3/0481

(52) U.S. Cl. CPC H04N 5/23216; G06F 3/0481; H04N 5/23293

(57) ABSTRACT

An imaging device includes a plurality of operating parts and circuitry. The circuitry is configured to invalidate an operation input with respect to a specific function among a plurality of functions assigned to the plurality of operating parts, according to a prescribed operation made by a user.

### CROSS-REFERENCE TO RELATED APPLICATION

This patent application is based on and claims priority pursuant to 35 U.S.C. § 119(a) to Japanese Patent Application No. 2016-232023, filed on Nov. 30, 2016, in the Japan Patent Office, the entire disclosure of which is hereby incorporated by reference herein.

### BACKGROUND

### Technical Field

Embodiments of the present disclosure relate to an a device.

### Background Art

A configuration in which an operation input to an operating part is locked (invalidated) has been known to prevent an erroneous in an imaging device.

For example, in this type of imaging device, the operating part (a main dial, etc.) is displayed in a list on a menu screen for lock operation selection. When the operating part is designated by a user operation from the list displayed on the menu screen, an operation input to the designated operating part is locked.

### SUMMARY

Embodiments of the present disclosure described herein provide an imaging device. The imaging device includes a plurality of operating parts and circuitry. The circuitry is configured to invalidate an operation input with respect to a specific function among a plurality of functions assigned to the plurality of operating parts, according to a prescribed operation made by a user.

### BRIEF DESCRIPTION OF THE DRAWINGS

A more complete appreciation of exemplary embodiments and the many attendant advantages thereof will be readily obtained as the same becomes better understood by reference to the following detailed description when considered in connection with the accompanying drawings.

FIG. 1 is a block diagram illustrating a configuration of an imaging device according to an embodiment of the present disclosure;

FIGS. 2A to 2C are schematic external views illustrating a configuration of the imaging device, according to an embodiment of the present disclosure;

FIG. 3 is a diagram illustrating a flowchart of a process related to locking and unlocking of an executed function in an embodiment of the present disclosure;

FIG. 4 is a diagram illustrating a flowchart of a process executed when any one of operating parts of the imaging device is operated in an embodiment of the present disclosure;

and

FIG. 5 is a rear view of an imaging device according to another embodiment of the present disclosure.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more central processing units (CPUs), digital signal processors (DSPs), application-specific-integrated-circuits (ASICs), field programmable gate arrays (FPGAs), computers or the like. These terms in general may be collectively referred to as processors.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Hereinafter, an imaging device according to an embodiment of the invention will be described with reference to drawings. In description below, a digital single-lens reflex camera will be described as an embodiment of the present disclosure. The imaging device is not restricted to the digital single-lens reflex camera. For example, the imaging device may be replaced with another type of apparatus having a photographing function such as a mirrorless single lens camera, a compact digital camera, a video camera, a camcorder, a tablet terminal, a personal handy phone system (PHS), a smartphone, a feature phone, a portable game machine, etc.

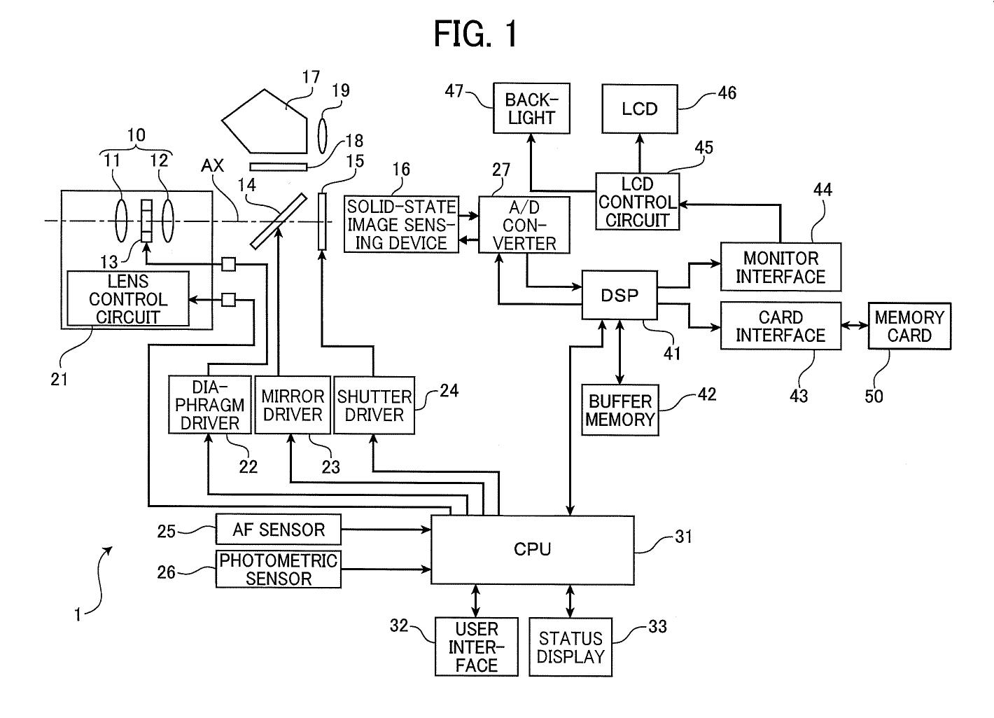

FIG. 1 is a block diagram illustrating a configuration of an imaging device 1 according to an embodiment of the present disclosure.

As illustrated in FIG. 1, the imaging device 1 includes a taking lens system 10 (taking lenses 11 and 12). A diaphragm 13 is disposed between the taking lens 11 and the taking lens 12. A mirror 14 is disposed behind the taking lens system 10. The mirror 14 is a half mirror disposed in a posture in which a half mirror surface forms about 45° with respect to an optical axis AX of the taking lens system 10.

The luminous flux (subject luminous flux) from a subject passes through the taking lens system 10 and is incident on the mirror 14. A focal-plane shutter 15 and a solid-state image sensing device 16 are disposed in order from the mirror 14 side, on a rear side of the mirror 14. A diffuser (a focusing plate or a focus plate) 18 and a pentaprism 17 are disposed in order from the mirror 14 side above the mirror 14.

A part of the subject luminous flux incident on the mirror 14 is reflected by the mirror 14 and is incident on the pentaprism 17 through the diffuser 18. The diffuser 18 is disposed at a position equivalent to the imaging surface of the solid-state image sensing device 16. For this reason, the subject luminous flux passing through the taking lens system 10 forms an image on the diffuser 18. The pentaprism 17 has a plurality of reflecting surfaces, forms an image on the diffuser 18, reflects an incident subject image on each of the reflecting surfaces to form an erected image, and emits the image toward an eyepiece 19. The eyepiece 19 forms an image on the diffuser 18 and re-images the subject image erected by the pentaprism 17 as a virtual image suitable for observation by a photographer. In this way, the photographer can observe the subject image by looking through the eyepiece 19.

A user interface 32 includes various operating parts such as a power switch, a release switch, an operation dial, an operation key, etc. used when a user operates the imaging device 1. When the user presses the power switch, power is supplied from a battery (not illustrated) to various circuits of the imaging device 1 through the power supply line. After power is supplied, a central processing unit (CPU) 31 accesses a predetermined memory area, reads a control program, loads the read control program in a work area, and executes the loaded control program, thereby controlling the entire imaging device 1.

The CPU 31 controls the driving of the diaphragm 13 through a diaphragm driver 22 such that appropriate exposure can be obtained based on a photometric value calculated on the basis of an image picked up by the solid-state image sensing device 16 and a photometric value measured by a photometric sensor 26. An appropriate exposure time, F value, etc. in a photographing mode or at a point in time of the photographing mode are displayed on a status display 33 (for example, a liquid crystal display (LCD)).

When the release switch is half-pressed, the CPU 31 controls positions of the taking lens 11 and the taking lens 12 and a positional relationship between the taking lens 11 and the taking lens 12 on the optical axis AX through a lens control circuit 21 based on a detection result of an autofocus (AF) sensor 25. In this way, a focusing state of the taking lens system 10 is adjusted. Subsequently, when the release switch is fully pressed, the CPU 31 controls the driving of the focal-plane shutter 15 through a shutter driver 24 and quickly returns the mirror 14. In other words, the CPU 31 raises the mirror 14 through a mirror driver 23 during a period from immediately before a start of a front curtain travel to immediately after an end of a rear curtain travel of the focal-plane shutter 15, thereby retracting the mirror 14 from an optical path parallel to the optical axis AX of the taking lens system 10.

The subject luminous flux passing through the taking lens system 10 is imaged on the imaging surface of the solid-state image sensing device 16 during a period in which the focal-plane shutter 15 is open. For example, the solid-state image sensing device 16 is a complementary metal oxide semiconductor (CMOS) image sensor, and accumulates an optical image formed at each pixel on the image surface as an electric charge corresponding to the amount of light. The solid-state image sensing device 16 converts the accumulated electric charge into a voltage (herein, referred to as a “pixel signal”) using a floating diffusion amplifier, and outputs the converted pixel signal to an analog/digital (A/D) converter 27. The A/D converter 27 A/D converts the input pixel signal and outputs the converted signal to a digital signal processor (DSP) 41.

The DSP 41 controls a charge accumulation operation and a pixel signal reading operation of the solid-state image sensing device 16 and performs predetermined signal processing on a pixel signal input from the A/D converter 27. Specifically, the DSP 41 performs predetermined signal processing such as color interpolation, matrix calculation, Y/C separation, etc. on the pixel signal input from the A/D converter 27 to generate a luminance signal Y and color difference signals Cb and Cr, and compresses the generated signals in a predetermined format such as joint photographic experts group (JPEG), etc. For example, a buffer memory 42 is used as a temporary storage location of processing data when the processing by the DSP 41 is executed.

A memory card 50 is detachably loaded in a card slot of a card interface 43. The DSP 41 can communicate with the memory card 50 through the card interface 43. The DSP 41 saves a generated compressed image signal (photographed image data) in the memory card 50 (or a built-in memory provided in the imaging device 1).

In addition, the DSP 41 performs predetermined signal processing on a signal after Y/C separation and buffers the signal in a frame memory in frame units. The DSP 41 sweeps the buffered signal from each frame memory at a predetermined timing, converts the signal into a video signal of a predetermined format, and outputs the signal to an LCD control circuit 45 through a monitor interface 44. The LCD control circuit 45 controls modulation of a liquid crystal based on photographed image data input from the DSP 41, and controls light emission of a backlight 47. In this way, the photographed image of the subject is displayed on a display screen of an LCD 46. The user may visually recognize a real-time through image of proper luminance photographed with an appropriate focus through the display screen of the LCD 46.

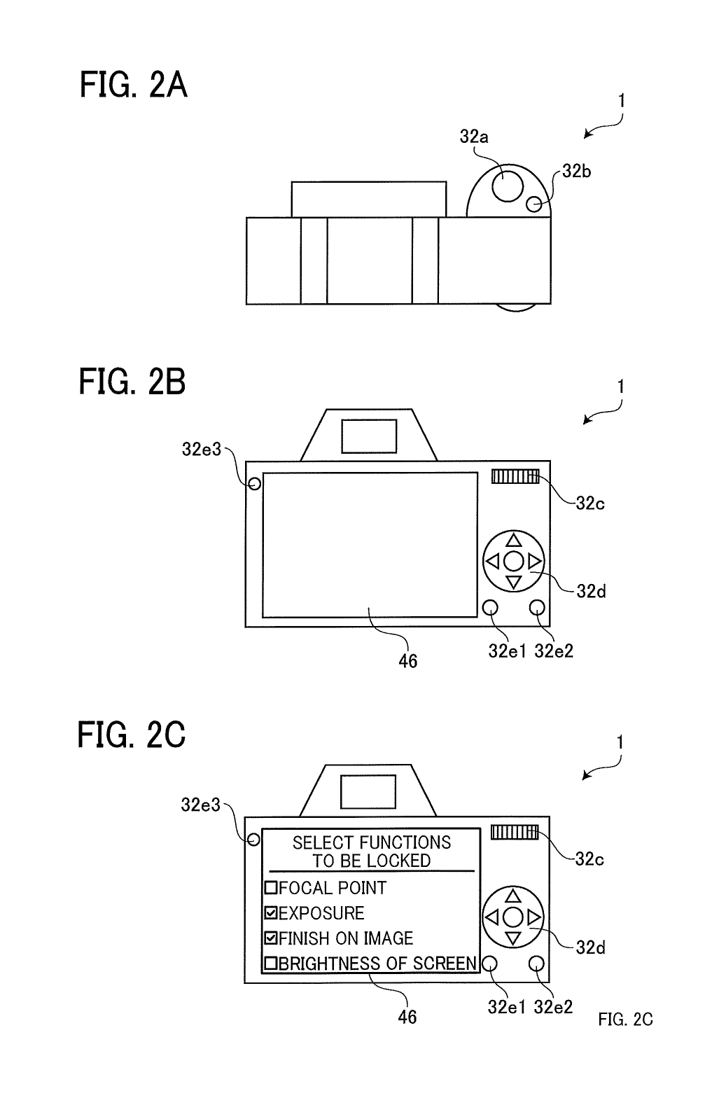

FIG. 2A illustrates a top view of the imaging device 1, according to the present embodiment.

FIG. 2B illustrates a rear view of the imaging device 1, according to the present embodiment.

As illustrated in FIG. 2A and FIG. 2B, various operating parts included in the user interface 32 are provided on an upper surface and a rear surface of a housing of the imaging device 1. Specifically, as illustrated in FIG. 2A, a release switch 32a and a lock button 32b included in a part of the user interface 32 are provided on the upper surface of the imaging device 1. As illustrated in FIG. 2B, an operation dial 32c, an operation key 32d, customize buttons 32e1, 32e2, and 32e3, and the LCD 46 included in a part of the user interface 32 are provided on the rear surface of the imaging device 1. The operation key 32d includes up, down, left and right direction keys and a determination key located at a center of the direction keys. The LCD 46 is a touch panel display and is included in a part of the user interface 32.

For example, functions such as exposure correction, automatic exposure (AE) lock, switching of a display of an electronic level, switching of a selection state of a focal point, deletion of an image, enlargement/reduction display of a reproduced image, white balance, selection of a photographing scene (portrait, sports, night view, distant view, etc.), selection of a saving format (RAW, JPEG, etc.), selection of a communication mode (Wi-Fi, Bluetooth, etc.), etc. may be assigned to any of the customize buttons 32e1, 32e2, and 32e3 in response to a touch operation on a customize button setting screen displayed on the LCD 46. These functions are illustratively assigned to any one of the operation dial 32c, the operation key 32d, and another operating part.

The user may perform locking and unlocking of a function through a lock target function setting screen displayed on the LCD 46. The function locking is to invalidate the operation input by the user instructing execution of the function. That is, when a function is locked, the function is not executed even when an operation input for the function is performed. In addition, the function unlocking is to validate the locked function. That is, when a function is unlocked, the unlocked function is executed according to an operation input for the function.

FIG. 2C illustrates a display example of the lock target function setting screen, according to the present embodiment.

In the present embodiment, the user may set a function to be locked as desired through the lock target function setting screen. However, in another embodiment, a function to be locked may not be set by the user, and a predetermined function (for example, a function to be frequently locked) may be locked and unlocked.

In an example of FIG. 2C, a function related to a focal point, a function related to exposure setting, a function related to the finish on images, a function related to brightness of the screen are displayed in a list on the LCD 46 as functions to be locked. Examples of the function related to the focal point include a function of switching a selection state of the focal point, a function of switching a ranging mode, etc. Examples of the function related to the exposure setting include a function of setting a diaphragm value, a shutter speed, and ISO sensitivity, an AE lock, etc. Examples of the function related to the finish on images include a white balance function, a function of selecting a photographing scene, etc. Examples of the function related to the brightness of the screen include a function of adjusting the brightness of the LCD 46, etc.

The user may check or uncheck a checkbox of each function on the lock target function setting screen by a touch operation. When the operation key 32d (determination key) is pressed by the user, a function whose check box is checked at this time is locked, and a function whose check box is not checked is excluded from objects to be locked.

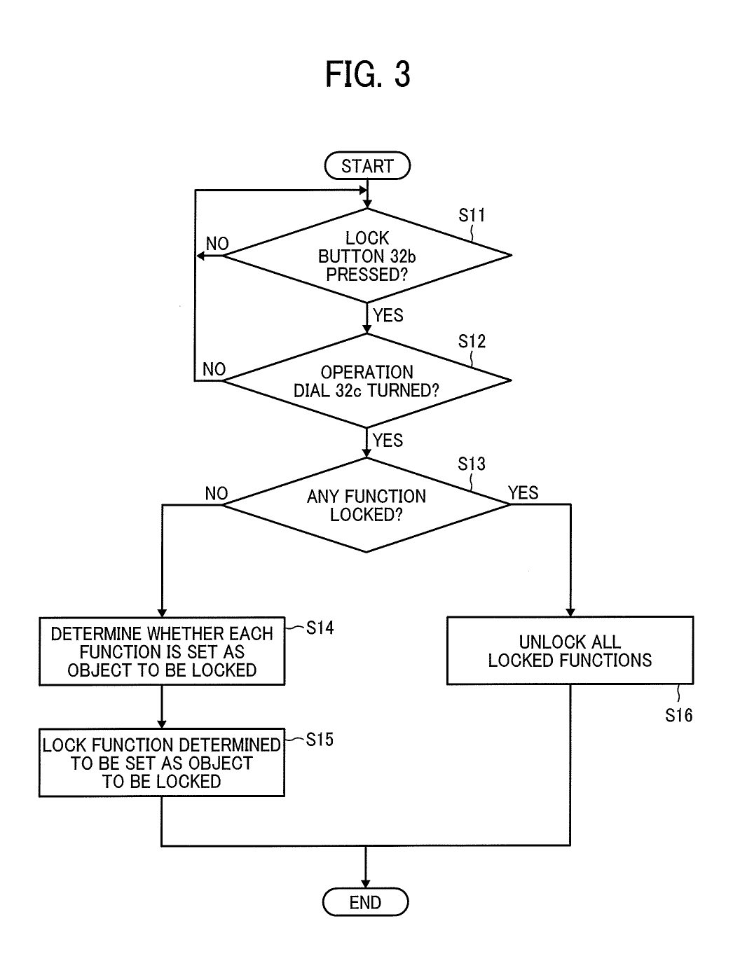

FIG. 3 is a diagram illustrating a flowchart of a process of locking and unlocking a function.

In a step S11 of FIG. 3, it is determined whether the lock button 32b has been pressed.

The process in a step S12 is executed when it is determined that the lock button 32b has been pressed in processing step S11 (S11: YES). In this processing step S12, it is determined whether the operation dial 32c has been turned. When it is determined that the operation dial 32c has not been turned (S12: NO), the process of this flowchart returns to the processing step S11 (operation determination for lock button 32b).

The process in a step S13 is executed when it is determined that the operation dial 32c has been turned in processing step S12 (S12: YES). In this processing step S13, it is determined whether the function is locked (more particularly whether at least one function is locked as a result of previous execution of this flowchart).

The process in a step S14 is executed when it is determined that the function is not locked in processing step S13 (determination of lock) (S13: NO). In this processing step S14, it is determined whether a checkbox is checked for each function displayed on the lock target function setting screen (in other words, whether each function is set as an object to be locked).

In the process in a step S15, a function determined to be set as the object to be locked in processing step S14 (determination of object to be locked) is locked. In an example of FIG. 2C, the function related to the exposure setting and the function related to the finish on images are locked.

The process in a step S16 is executed when it is determined that the function is locked (S13: YES). In this processing step S16, all locked functions are unlocked.

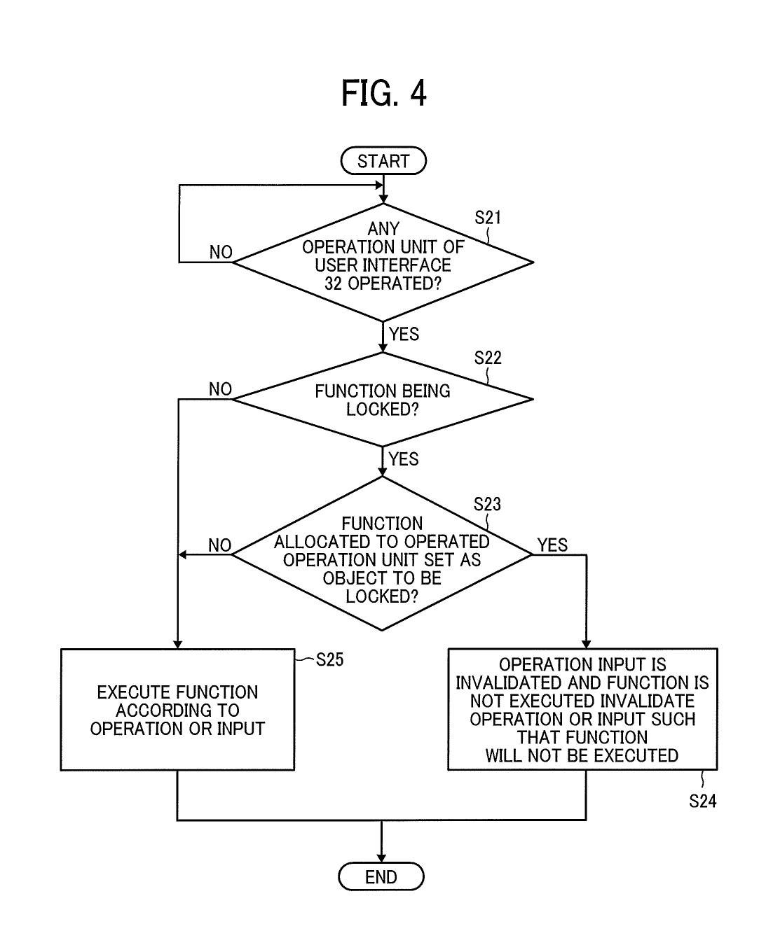

FIG. 4 is a diagram illustrating a flowchart of a process executed when any one of the operating parts included in the user interface 32 is operated, according to the present embodiment.

In the process in a step S21, it is determined whether any one of the operating parts included in the user interface 32 has been operated.

The process in a step S22 is executed when it is determined that any one of the operating parts included in the user interface 32 has been operated in processing step S21 (determination of operation) (S21: YES). In this processing step S22, it is determined whether a function is locked. When it is determined that the function is not locked (S22: NO), the process of this flowchart proceeds to processing step S25 (execution of function).

The process in a step S23 is executed when it is determined that the function is locked in processing step S22 (determination of lock) (S22: YES). In this processing step S23, it is determined whether a function assigned to an operating part determined to have been operated in processing step S21 (determination of operation) has been set as an object to be locked.

Among the operating parts included in the user interface 32, there is an operation whose assigned function is switched depending on the state (for example, a photographing mode, a reproduction mode, a menu mode, etc.) of the imaging device 1. As an example, a function of setting a diaphragm is assigned to the operation dial 32c in the photographing mode, and a function of enlarging/reducing a reproduced image displayed on the LCD 46 is assigned to the operation dial 32c in the reproduction mode. Therefore, in this processing step S23, an object to be locked is determined by taking the state of the imaging device 1 into consideration.

The photographing mode is a mode in which a still image or a moving image is photographed. The reproduction mode is a mode in which a still image or a moving image stored in the built-in memory of the imaging device 1 or the memory card 50 is reproduced on the LCD 46. The menu mode is a mode in which a menu screen operable by the user is displayed on the LCD 46.

For example, a case in which the operation dial 32c is operated while the function relate to the exposure setting is locked by execution of processing illustrated in FIG. 3 is considered. In this case, when the imaging device 1 is set to the photographing mode, since a function assigned to the operation dial 32c corresponds to the function of setting the diaphragm value, it is determined that the function is set as an object to be locked in this processing step S23 (S23: YES). On the other hand, when the imaging device 1 is set to the reproduction mode, since a function assigned to the operation dial 32c corresponds to the function of enlarging/reducing the reproduced image, it is determined that the function is not set as an object to be locked in this processing step S23 (S23: NO).

The process in a step S24 is executed when it is determined that the function assigned to the operating part is set as an object to be locked in processing step S23 (determination of object to be locked) (S23: YES). In this processing step S24, the operation input is invalidated. In this way, the process of this flowchart ends without the function being executed.

The process in a step S25 is executed when it is determined that the function is not locked in processing step S22 (determination of lock) (S22: NO) or when it is determined that the function assigned to the operating part is not set as an object to be locked in processing step S23 (determination of object to be locked) (S23: NO). In this processing step S25, the function is executed depending on the operation input.

As described above, in the present embodiment, it is possible to perform lock setting for the function rather than the operating part. For this reason, for example, even when the user forgets which function is assigned to the customize button 32e1, etc., the user may accurately lock a desired function. In addition, in the present embodiment, for example, even when a function assigned to the customize button 32e1, etc. is switched depending on the state of the imaging device 1, the operation input is invalidated for a period at which a function desired to be locked is assigned to the customize button 32e1, etc. Therefore, according to the present embodiment, improvement of operability with regard to lock setting is achieved.

Next, a description will be given of a specific example when the customize button 32e1 is operated under the following conditions.

In this specific example, the function related to the exposure setting is set as a function to be locked. A function assigned to the customize button 32e1 for each state of the imaging device 1 is as follows.
Function assigned to the customize button 32e1 in the photographing mode: Exposure correction
Function assigned to the customize button 32e1 in the reproduction mode: Enlargement of reproduced image
Function assigned to the customize button 32e1 in the menu mode: Switching of a selected item in the menu screen

In this specific example, when the customize button 32e1 is operated in the photographing mode, since the exposure correction function is an object to be locked, the operation input is invalidated, and exposure correction is not performed. On the other hand, when the customize button 32e1 is operated in the reproduction mode or the menu mode, since the function of enlarging the reproduced image or the function of switching the selected item on the menu screen is an object to be locked, the operation input is invalidated, and enlargement of the reproduced image or switching of the selected item on the menu screen is performed. That is, in this specific example, since the operation input to the customize button 32e1 is not locked, and lock setting is performed for the function, the operation input is validated or invalidated depending on the state of the imaging device 1 (more precisely, the function assigned to customize button 32e1 at an operation point).

It is presumed that the function assigned to the customize button 32e1 in the photographing mode is changed from the exposure correction function to the function of switching the selection state of the focal point. In this case, since the function of switching the selection state of the focal point is excluded from objects to be locked, the operation input is valid in the photographing mode unlike the case of the exposure correction function. That is, in this specific example, since the operation input to the customize button 32e1 is not locked, and lock setting is performed for the function, when the function assigned to the customize button 32e1 is changed, the operation input is validated or invalidated depending on the function after setting change.

An illustrative embodiment of the present disclosure has been described above. Embodiments of the present disclosure are not limited to the above description, and various modifications may be made within the scope of the technical idea of the present disclosure. For example, content obtained by appropriately combining an embodiment clearly exemplified in the specification, an obvious embodiment, etc. is included in the embodiment of the present disclosure.

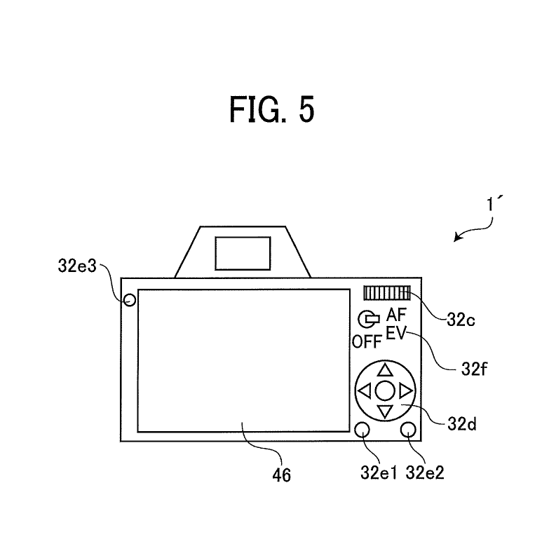

FIG. 5 illustrates a rear view of an imaging device 1′ according to another embodiment of the present disclosure.

As illustrated in FIG. 5, a lock target function switching lever 32f is provided on a rear surface of the imaging device 1′. The user may collectively lock and unlock a function group including a plurality of related functions by operating the lock target function switching lever 32f.

When the lock target function switching lever 32f is adjusted to an “AF” position by a user operation, a function related to AF is locked. For this reason, even when an operating part to which the function related to AF is assigned is operated among respective operating parts included in a user interface 32, the function is not executed. For an operating part to which another function is assigned, a function corresponding to an operation is executed. Examples of the function related to AF include continuous AF/single AF, an AF area selection mode, an AF position (spot) selection mode, etc. When the lock target function switching lever 32f is adjusted to the “AF” position, all functions related to AF (all function groups related to AF) may be locked, or some functions in the function groups related to AF may be locked by user setting.

When the lock target function switching lever 32f is adjusted to an “EV” position by a user operation, a function related to exposure setting is locked. For this reason, even when an operating part to which the function related to exposure setting is assigned is operated among the respective operating parts included in a user interface 32, the function is not executed. For an operating part to which another function is assigned, a function corresponding to an operation is executed. Examples of the function related to exposure setting include a shutter speed, a diaphragm, ISO sensitivity, exposure correction, etc. When the lock target function switching lever 32f is adjusted to the “EV” position, all functions related to exposure setting (all function groups related to exposure setting) may be locked, or some functions in the function groups related to exposure setting may be locked by user setting.

When the lock target function switching lever 32f is adjusted to an “OFF” position by a user operation, all functions are excluded from objects to be locked. For this reason, a function corresponding to an operation is executed for all the operating parts.

According to another embodiment of the present disclosure, for example, even in a state in which power of the imaging device 1′ is not turned ON, the user may perform lock setting by operating the lock target function switching lever 32f. In addition, the user may change lock setting by a simple operation in which a position of the lock target function switching lever 32f is changed.

Numerous additional modifications and variations are possible in light of the above teachings. It is therefore to be understood that within the scope of the appended claims, the present disclosure may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An imaging device comprising:
a plurality of operating parts; and
circuitry configured to invalidate an operation input with respect to a specific function among a plurality of functions assigned to the plurality of operating parts, according to a prescribed operation made by a user.

2. The imaging device according to claim 1, wherein the circuitry determines a function for which an operation input is invalidated or a group of functions including a plurality of related functions, according to an operation made by a user.

3. The imaging device according to claim 1, wherein the circuitry assigns any function selected by a user to one of the plurality of operating parts.

4. The imaging device according to claim 1, wherein a function assigned to at least one of the plurality of operating parts is switched according to a state of the imaging device.
